(19) United States
(12) Patent Application Publication
(10) Pub. No.: US 2008/0299254 A1
(43) Pub. Date: Dec. 4, 2008

(54) METHOD OF MAKING TOFU USING PROBIOTIC LACTOBACIULLS

(76) Inventors: JONG BOO KIM, DAEGU (KR); EUN JU LEE, GUMI-SI (KR); HYUN JIN JEONG, DAEGU (KR); KYUNG JA LEE, DAEGU (KR); KYOUNG HWA KIM, DAEGU (KR); WOO DONG PARK, DAEGU (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/960,603

(22) Filed: Dec. 19, 2007

(30) Foreign Application Priority Data
May 29, 2007 (KR) 10-2007-0052352

(51) Int. Cl. A23C 20/02; A23L 1/20

(52) U.S. Cl. 426/46; 426/61

(57) ABSTRACT

Disclosed is a process for the preparation of ground, processed and fermented bean curd (i.e., tofu) using probiotic lactobacillus. Bean curd is prepared from micronized full-fat soy flour without separating bean-curd dregs. Probiotic lactobacillus and transglutaminase enzyme are used for fermentative production of bean curd while no artificial coagulant is employed.

### CROSS-REFERENCE TO RELATED PATENT APPLICATIONS

This application claims the benefit of Korean Patent Application No. 10-2007-0052352, filed on May 31, 2007, in the Korean Intellectual Property Office, the disclosure of which is incorporated herein its entirety by reference.

### BACKGROUND

1. Field

The present disclosure relates to a method of making tofu, and more specifically, to a method of making tofu using lactobacillus.

2. Discussion of the Related Technology

Korean Patent Laid-Open No. 2006-0107245 discloses a process for preparing ground and processed wet bean curd (or wet whole tofu), which includes the steps of providing soybean, soaking the soybean in water (for twenty hours), grinding, heating, filtering, adding the separated bean-curd dregs, and adding enzymes and coagulants. The separated bean-curd dregs are not discarded, and enzymes and coagulants are used for making bean curd.

Korean Patent Laid-Open Nos. 2007-0015983 and 2006-0107245 disclose methods for preparing ground and processed bean curd, which comprises the steps of providing soybean, soaking the soybean in water, rough grinding, heating, ultra-fine grinding, adding enzymes and coagulants, and obtaining bean curd.

Production of ground and processed bean curd from micronized full-fat soy flour is disclosed in several Korean patents including Korean Patent Registration No. 0577768. However, the above methods have disadvantages as coagulants such as brine are used together with an enzyme. The coagulants should be removed completely before obtaining the final product.

For solving such problems related with coagulants, Korean Patent Laid-Open No. 2000-0071902 discloses that juice of kim-chi which contains lactobacillus with low pH is used as a coagulant for soy milk.

In addition, Korean Patent Laid-Open No. 1999-0065688 discloses a method for producing bean curd based on lactobacillus fermentation, wherein soybean is soaked in water and ground with addition of water, shaken at 70-100° C. for 30 minutes for homogenization, and then soybean cake is separated using non-woven fabric to obtain soy milk. Sugar is added and lactobacillus is introduced for fermentation to the soy milk. Because of using lactobacillus instead of salts such as brine, etc. for coagulation, the resulting bean curd is free of any salts such as brine, etc. However, the above method is disadvantageous in that soybean cake has to be removed and the coagulation of bean curd is not accomplished well so that the final bean curd is difficult to have a typical tofu shape.

The foregoing discussion is to provide general background information, and does not constitute an admission of prior art.

### SUMMARY

One aspect of the invention provides tofu, which comprises: microorganisms of Lactobacillus plantarum contained in Deposit No. KCCM10852P; and a transglutaminase enzyme.

In the foregoing tofu, the tofu may contain the microorganisms in the number ranging from about 1×10⁸/g to about 9×10⁸/g. The tofu may contain water in an amount from about 85 to about 90 wt %. The tofu may have a hardness value from about 322 to about 368 dyn/cm², wherein the hardness value is obtainable by subjecting a cube of tofu (1.7×1.7×1.7 cm) to a test using Texture analyzer TA. XT. Plus available from Stable Micro Systems in U.K. under the conditions as set forth in the table:

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

The tofu may have a springiness value from about 0.84 to about 0.90%, wherein the hardness value is obtainable by subjecting a cube of tofu (1.7×1.7×1.7 cm) to a test using Texture analyzer TA. XT. Plus available from Stable Micro Systems in U.K. under the conditions as set forth in the table:

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

Another aspect of the invention provides a method of making tofu, which comprises: providing soy milk; adding to the soy milk a transglutaminase enzyme and microorganisms of Lactobacillus plantarum contained in Deposit No. KCCM10852P; and aging the resulting composition for a period sufficient for fermentation by the microorganism, wherein the fermentation generates a coagulant for coagulating tofu.

In the foregoing method, the period may be from about 5 to about 12 hours. Aging for fermentation may be at a temperature from about 37 to about 45° C. The method does not comprise adding a coagulant other than that generated from the fermentation. The method does not comprise press-shaping the tofu. The resulting tofu may contain the microorganisms in the number ranging from about 1×10⁸/g to about 9×10⁸/g. The tofu may contain water in an amount from about 85 to about 90 wt %. Providing the soy milk may comprise adding water to micronized full-fat soy flour.

Still in the foregoing method, the resulting tofu may have a hardness value from about 322 to about 368 dyn/cm², wherein the hardness value is obtainable by subjecting a cube of tofu (1.7×1.7×1.7 cm) to a test using Texture analyzer TA. XT. Plus available from Stable Micro Systems in U.K. under the conditions as set forth in the table:

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

The resulting tofu may have a springiness value from about 0.84 to about 0.90%, wherein the hardness value is obtainable by subjecting a cube of tofu (1.7×1.7×1.7 cm) to a test using Texture analyzer TA. XT. Plus available from Stable Micro Systems in U.K. under the conditions as set forth in the table:

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

An aspect of the present invention provides a process for the preparation of ground, processed and fermented bean curd (or whole tofu) using probiotic lactobacillus. More specifically, an aspect of the present invention provides a process for preparing ground and processed bean curd from micronized full-fat soy flour without separating bean-curd dregs, probiotic lactobacillus and transglutaminase enzyme are used for fermentative production of bean curd while no artificial coagulant is used.

The tofu according to embodiments of the present invention is remarkable and clearly distinguished from typical tofu in that, not only the proteins, nutritional components, and functional materials from soy but also physiologically active materials that are produced by probiotic lactobacillus are comprised in ground, processed and fermented bean curd that is prepared according to embodiments of the present invention, making it a nutritionally excellent food. Furthermore, because bean-curd dregs are not produced and soy flour is used in 100% to provide the ground, processed and fermented bean curd, it can be said that the process of an embodiment of the present invention is an economically favorable, efficient, and clean preparation method which does not involve any pollution of the environments.

An aspect of the present invention provides a bean curd having high coagulation quality by using lactobacillus fermentation instead of coagulants. An aspect of the present invention provides a process for providing ground, processed and fermented bean curd using probiotic lactobacillus without separating any bean-curd dregs, wherein said fermented bean curd maintains full nutrients of soybean and has excellent springness, strength and texture.

An aspect of the present invention provides a process for producing bean curd, which comprises steps of adding purified water to micronized full-fat soy flour followed by boiling the mixture, cooling down the boiled soy milk, adding lactobacillus strain and transglutaminase enzyme to the soy milk, and subjecting the resulting mixture to fermentation.

The micronized full-fat soy flour is added in an amount of from 5 wt % to 20 wt % compared to purified water for boiling, and lactobacillus strain and transglutaminase enzyme are added in an amount of from 0.05 wt % to −0.3 wt %, respectively compared to purified water. The fermentation step is carried out at 37-45° C. for five to twelve hours.

When purified water is added to micronized full-fat soy flour, one or more of functional materials or raw herbal materials that are selected from a group consisting of red ginseng, green tea powder, chlorella, and licorice extract can be added as an ingredient for preparing ground and processed bean curd. Preferably, they can be added in an amount of from about 0.1 wt % to about 3.0 wt % compared to purified water.

In the process for preparing bean curd according to an embodiment of the present invention, the fermented bean curd is produced from micronized full-fat soy flour, and probiotic lactobacillus strain and transglutaminase enzyme are used instead of adding coagulants for bean curd, so that the resulting bean curd is rich in nutrition and additionally comprises physiologically active materials that are produced by soybean and the lactobacillus strain.

### BRIEF DESCRIPTION OF THE DRAWINGS

FIG. 1 shows a cross-sectional view of ground, processed and fermented bean curds, which have been prepared with different amount of soy flour.

FIG. 2 shows cross-sectional view of the fermented bean curd of the present invention and a commercially available bean curd.

### DETAILED DESCRIPTION OF EMBODIMENTS

Various embodiments of the invention will be described below.

The process of an embodiment of the present invention comprises:

1) adding about 8 wt % to about 18 wt % of purified water to about 300 to about 600 mesh, micronized full-fat soy flour and mixing them well,

2) boiling the resultant soy milk to which purified water has been added at the temperature of about 95° C. or above for about ten to about twenty minutes,

3) adding lactobacillus strain and transglutaminase enzyme, which increases bonding strength of soy protein, to the cooled-down soy milk with an amount of about 0.05 wt % to about 0.1 wt %, respectively, and

4) aging the soy milk, lactobacillus strain and transglutaminase enzyme to ferment the soy milk at the temperature of about 37° C. to about 45° C. for five to twelve hours to provide ground, processed and fermented bean curd.

Without any pressure process, bean curd produced by the above-described process can be easily shaped in accordance with the shape of a container to which it is packaged. By changing the amount of purified water added to full-fat soy flour, bean curd having different texture or hardness can be produced. For example, when a high amount of purified water is used, bean curd in a form of soft bean curd can be obtained. On the other hand, when a small amount of purified water is used, bean curd with high hardness can be obtained. Furthermore, when higher amounts of lactobacillus strain and the enzymes are used, the time required for fermentation can be reduced.

According to a typical method of making wet tofu, soybeans are washed and soaked in water for at least ten hours. Then, after adding water and grinding the soybeans, resulting soy liquid is subjected to a heat treatment and filtered to separate bean-curd dregs from soy milk. The resulting soy milk is cooled and a coagulant is added thereto. After dehydrating, pressing and shaping thus-obtained bean curd, the final product can be obtained. Because said method requires at least twelve hours to produce bean curd and more than 30% of soybeans are wasted as bean-curd dregs, it would cause nutritional loss and environmental contamination. On the other hand, according to the process of an embodiment of the present invention, ground and processed bean curd is prepared by grinding whole beans while bean-curd dregs are not separated off. The ground and processed bean curd produced according to an embodiment of the present invention includes all the nutritional components of soybean as well as dietary fiber that is not included in bean curd prepared by typical methods of making tofu. In addition, the process of an embodiment of the present invention reduces loss of nutritional components of soybean such as carbohydrates, saponin, isoflavone, and vitamins, etc. during the process of breaking and pressing included in the typical methods.

Ground and processed bean curd (or whole tofu) can be classified into wet ground and processed bean curd and dry ground and processed bean curd. Meanwhile, according to Korea Food Additives Code, it is stipulated that “ground and processed bean curd refers to bean curd product manufactured by adding coagulant to finely powdered soy bean (100%) that is melted and heated in moisture.” Thus, strictly speaking, it appears that the dry ground and processed bean curd which is prepared from soy flour is more close to pure ground and processed bean curd than wet ground and processed bean curd which is prepared using bean-curd dregs that are processed and re-used.

The process of an embodiment of the present invention is completely distinguished from typical methods of preparing bean curd. Specifically, without using a coagulant that is usually used for preparing bean curd, the action of lactic acid produced during the fermentation of lactobacillus and transglutaminase enzyme contribute to the coagulation and bonding of soy proteins so that smooth-textured bean curd without pores can be produced.

The process of an embodiment of the present invention can reduce loss in nutrition due to the occurrence of bean-curd dregs, loss in production yield and need for removing waste water, etc. Therefore, production cost can be reduced thanks to improvements in efficiency for the utilization of raw materials, improvements in production yield and production time. Furthermore, bean-curd can be produced more hygienically without yielding any environmentally unfavorable wastes. Moreover, the occurrence of air bubble inside bean curd, unfavorable texture and springness, etc., can be reduced by the process of an embodiment of the present invention, whereby fermented bean curd with compact texture and excellent springness can be produced.

The lactobacillus strain mentioned above preferably belongs to genus Lactobacillus or genus Leuconostoc. For example, strains of Lactobacillus acidophilus, Lactobacillus bulgaricus, Lactobacillus casei, Leuconostoc mesenteroides, Enterococcus faecalis, and Lactoccus lactis, etc. can be mentioned.

Particularly, lactobacillus in an embodiment of the present invention is Lactobacillus plantarum, which was deposited as Deposit No. KCCM10852P at Korean Culture Center of Microorganisms on Apr. 11, 2007 under Budapest Treaty on the International Recognition of the Deposit of Microoragnisms. A receipt of the deposit is reproduced immediately before the claims of this application. Compared to other publicly known strains of genus Lactobacillus, said the deposited Lactobacillus plantarum has an excellent curd-forming ability and generates less acidic taste in soy milk.

Lactobacillus plantarum (Deposit No. KCCM10852P) has been isolated from kim-chi, which is a traditional Korean fermentation food. Lactobacillus plantarum has been also found as a microbe which is great in growing ability, acid-producing ability, and curd-forming ability. Said selected strain was finally identified and deposited with Korean Culture Center of Microorganisms (KCCM) under the name of Lactobacillus plantarum NUC-J1 (Deposit No. KCCM10852P).

Further, the above-described Lactobacillus plantarum NUC-J1 (Deposit No. KCCM10852P) can produce soy milk yogurt in a form of paste when the solid content of soy milk is less than about 10%, while it can produce fermented bean curd when the solid content of soy milk is the same or above about 10%.

Lactobacillus strain can be prepared by culturing bacterial cells in MRS lactobacillus media for 48 hours, and removing cell bodies from the culture by centrifuge. To the recovered cell bodies lactose is then added as a bulking agent. Resulting mixture can be subjected to a freeze-drying process. Consequently, lactobacillus strain can be prepared and used in a freeze-dried powder form.

Examples of the present invention will be further illustrated, which are only to assist understanding thereof but are not to be construed in any way imposing limitation upon the scope thereof.

### EXAMPLE 1

### Preparation of Lactobacillus-Fermented, Ground and Processed Bean Curd

To 88 g of purified water, 12 g of micronized full-fat soy flour (produced in U.S.A) was added to give 100 g of soy milk. After boiling the mixture for 15 minutes and subsequent cooling, 0.1 gram of freeze-dried powder of Lactobacillus plantarum (Deposit No. KCCM10852P) and 0.1 gram of transglutaminase (product of Ajinomoto, JAPAN, imported) were added thereto and fermentation was carried out at the temperature of 42° C. for six hours. As a result, ground and processed bean curd (or whole tofu) having soft texture was obtained.

### EXAMPLE 2

### Quality Determination of the Ground, Processed and Fermented Bean Curd that is Prepared Using Various Concentration of Micronized Full-Fat Soy Flour

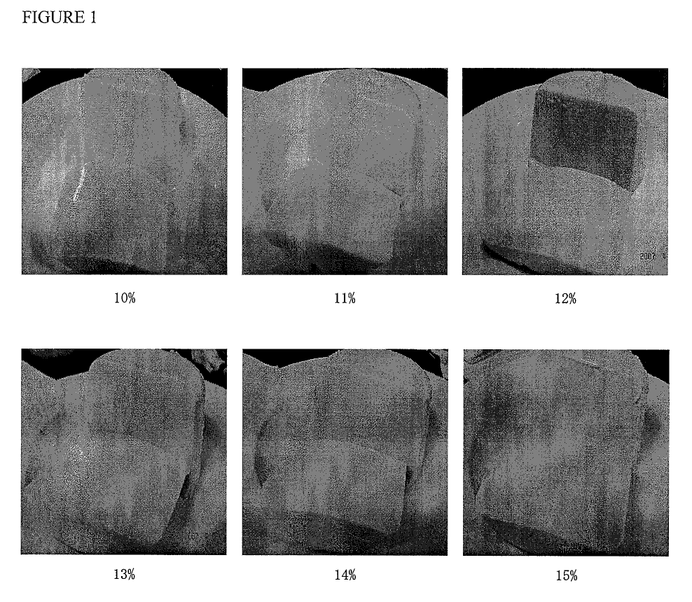

Ground, processed and fermented bean curd was produced with the same method as described in Example 1 while concentration of micronized full-fat soy flour was varied. For the various fermented bean curd obtained therefrom, pH, acidity, and the number of lactobacillus microbes were measured. Results are summarized in Table 1 given below. Meanwhile, FIG. 1 shows the cross-sectional image of the ground, processed and fermented bean curd of the present invention.

Acidity was measured using 0.1N NaOH titration method as described in Korea Food Additives Code. For measuring the number of lactobacillus microbes, a general method for determining lactobacillus was employed by which samples are plated on BCP agar plate in dilution and then the number of colonies which express yellow color was counted.

Among various kinds of bean curd comprising different concentration of soy flour, there was no significant difference observed for pH, acidity, and the number of lactobacillus microbes. Acidity of the bean curd prepared according to an embodiment of the present invention was at most 0.18% (based on lactic acid), which is the acidity criteria for general milk as stipulated in Korea Food Additives Code. Functionally, acidity did not affect the flavor of the bean curd. Lactobacillus was present in a number of at least one hundred million in the bean curd, which corresponds to the level of ‘concentrated fermented milk’ described in Korea Food Additives Code.

For the bean curd comprising the solid components in an amount of the same or less than 12%, a slight separation between layers was observed, as it can be seen from the cross-sectional view of the bean curd. On the other hand, for the bean curd comprising the solid components in an amount of more than 12%, ground, processed and fermented bean curd without such separation between layers was produced successfully.

The following Table 1 summarizes the data of pH, acidity, and the number of lactobacillus microbes for the ground, processed and fermented bean curd that have been produced with various content of soy flour.

TABLE 1

| Content of solid components (fine soy flour) | | | | | |
|---|---|---|---|---|---|
| 10% | 11% | 12% | 13% | 14% | 15% |

| | | | | | | |
|---|---|---|---|---|---|---|
| pH | 5.3 | 5.0 | 5.1 | 5.2 | 5.3 | 5.3 |
| Acidity | 0.12 | 0.11 | 0.16 | 0.14 | 0.13 | 0.13 |
| Number of | 5.2 × 10⁸ | 3.3 × 10⁸ | 4.3 × 10⁸ | 2.7 × 10⁸ | 3.4 × 10⁸ | 4.2 × 10⁸ |
| lactobacillus | | | | | | |
| microbes per 1 g | | | | | | |
| of tofu | | | | | | |

FIG. 1 shows the cross-sectional images of the ground, processed and fermented bean curd that have been produced with various content of soy flour.

As it can be seen from the cross-sectional images of FIG. 1, the bean curd produced according to the process of an embodiment of the present invention comprises substantially free of air bubble within and has a texture that is compact, smooth and silky.

### EXAMPLE 3

### Quality Determination of the Ground Processed and Fermented Bean Curd that is Prepared with Various Time of Fermentation

Ground and processed bean curd was produced with the same method as described in Example 1 while various fermentation time was applied. For the various fermented bean curd obtained therefrom, pH, acidity, and the number of lactobacillus microbes were measured. Results are summarized in Table 2 given below.

As pH becomes lower over the lapse of fermentation time, the bean curd having stronger acid taste was produced after eight hours of the fermentation. Considering the flavor, it is preferable to keep the fermentation time the same or less than about eight hours. Table 2 given below shows the data for the quality of the bean curd that is prepared with various time of fermentation.

TABLE 2

| | Fermentation time | | | | |
|---|---|---|---|---|---|
| | 6 | 7 | 8 | 9 | 10 |
| pH | 5.3 | 4.9 | 4.9 | 4.9 | 4.8 |
| Acidity | 0.12 | 0.14 | 0.19 | 0.22 | 0.22 |
| Number of | 5.2 × 10⁸ | 4.6 × 10⁸ | 4.6 × 10⁸ | 4.7 × 10⁸ | 4.4 × 10⁸ |
| lactobacillus | | | | | |
| microbes per | | | | | |
| 1 g of tofu | | | | | |

### EXAMPLE 4

### Texture Determination of the Fermented Bean Curd

By using Texture analyzer TA. XT. Plus [Stable Micro Systems (U.K)], texture of the bean curd that has been produced according to the process of an embodiment of the present invention was determined by measuring the force that is required to bring a change in shape of the bean curd, when a bean curd having certain size (1.7×1.7×1.7 cm) was prepared and pressed uniformly. As a result, the bean curd was evaluated for their hardness, adhesiveness, springiness, cohesiveness, gumminess, chewiness and resilience, respectively.

Specific conditions for such measurements are described in Table 3 below. Meanwhile, Table 4 describes the result of texture measurement for three different kinds of bean curd. Results for the texture measurement for the bean curd are an average value obtained from six to seven pieces of the same bean curd (all have been cut in the same size).

Content of solid mass of soy flour was 10%, 13% and 15% for the ground, processed and fermented bean curd Sample A, Sample B and Sample C, respectively. It was shown that the hardness of Sample A, B and C is close to that of a commercially available bean curd for pan-frying. Except for Sample A, adhesiveness was high for all the samples tested. Especially, Sample A has higher values of springiness, cohesiveness, gumminess, chewiness and resilience compared to other samples although its hardness and adhesiveness values were low. As such, it is believed that Sample A is softer and better in springiness compared to others. In addition, Sample C showed the texture value which is similar to that of a commercially available bean curd for pan-frying.

TABLE 3

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

There was not much of difference in hardness among the bean curd having various concentrations of solid components. Still, the best hardness was obtained for the bean curd having the content of solid components at 15%.

From the results described above, it can be said that the bean curd prepared according to the process of an embodiment of the present invention has higher hardness compared to commercially available bean curd, showing more firm and homogeneous shape compared to commercially available ones.

Generally, smooth-textured bean curd having no void volume is present in a soft bean curd form, which has relatively low hardness. However, the bean curd that is prepared according to the process of an embodiment of the present invention has a structure of texture which is similar to silky bean curd so that a firm-shaped bean curd with high binding property can be produced.

TABLE 4

| | Hardness | Adhesiveness | Springiness | Cohesiveness | Gumminess | Chewiness | Resilience |
|---|---|---|---|---|---|---|---|
| Sample | (dyn/cm²) | (g) | (%) | (%) | (g) | (g) | (%) |
| A | 322.6 | 10.7 | 0.90 | 0.67 | 225.5 | 196.0 | 0.29 |
| B | 333.3 | 41.1 | 0.84 | 0.43 | 140.3 | 117.6 | 0.16 |
| C | 368.1 | 39.8 | 0.86 | 0.54 | 204.9 | 173.3 | 0.23 |
| Commercially | 378.3 | 46.5 | 0.88 | 0.56 | 214.8 | 176.7 | 0.23 |
| available bean | | | | | | | |
| curd for pan- | | | | | | | |
| frying | | | | | | | |

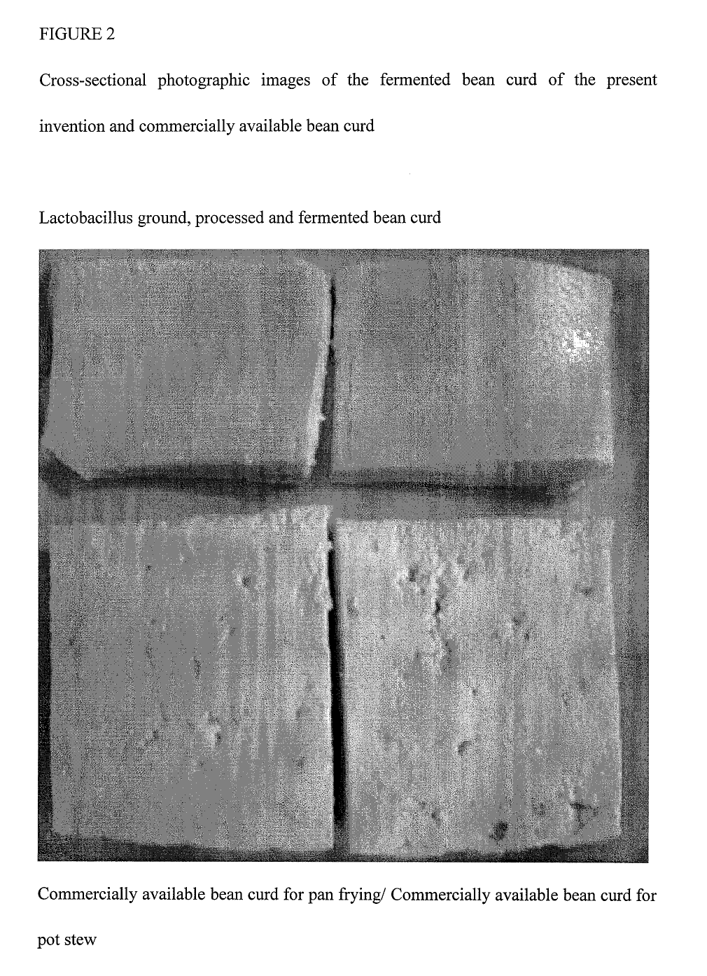

FIG. 2 shows cross-sectional images of the fermented bean curd of the present invention and a commercially available bean curd. It is found that the ground, processed and lactobacillus-fermented bean curd of the present invention has better hardness (i.e., degree of firmness) than the commercially available bean curd.

When bean curd are prepared according to the method as described in above Example 1, herbal plants including red ginseng powder, tea leaf powder, turmeric powder, and licorice powder, etc. and functional raw materials including chlorella powder can be added in an amount of 0.5 wt % to 3 wt %, together with soy flour. By doing so, various kinds of ground, processed and fermented bean curd having improved functionality and flavor can be prepared.

Search and Identification of Lactobacillus plantarum (Deposit No. KCCM10852P)

Lactobacillus strain that is used for the process of an embodiment of the present invention as described above has been isolated from kim-chi as a source, which is a traditional Korean fermentation food. BCP agar plate, which is a media for identifying lactobacillus strains, was used for further separation and isolation. From soy milk as a plant source, microbial strain having excellent growing ability, acid-producing ability, and curd-forming ability was finally selected. The selected lactobacillus strain was identified as Lactobacillus plantarum with 99.9% homology using API Kit 50CHL by Korean Culture Center of Microorganisms (KCCM). After the deposition with KCCM, the strain was given with the Deposit No. KCCM 10852P.

Cultural and biochemical characteristics of the novel microbe Lactobacillus plantarum (Deposit No. KCCM10852P) according to an embodiment of the present invention are summarized in the following Table 5.

TABLE 5
Sugar-using ability of Lactobacillus plantarum NUC-J1
(Deposit No. KCCM10852P)

| | Strain | API CHL |
|---|---|---|
| 0 | Control | − |
| 1 | Glycerol | − |
| 2 | Ertythritol | − |
| 3 | D-Arabinose | − |
| 4 | L-Arabinose | + |
| 5 | Ribose | + |
| 6 | D-Xylose | − |
| 7 | L-Xylose | − |
| 8 | Adonitol | − |
| 9 | β Methyl xyloside | − |
| 10 | Galactose | + |
| 11 | D-Glucose | + |
| 12 | D-Fructose | + |
| 13 | D-mannose | + |
| 14 | L-sorbose | − |
| 15 | Rhamnose | + |
| 16 | Dulcitol | − |
| 17 | Inositol | − |
| 18 | Mannitol | + |
| 19 | Sorbitol | − |
| 20 | A ethyl-D-mannoside | + |
| 21 | α Methyl-D-glucoside | − |
| 22 | N Acethl glucosamine | + |
| 23 | Amygdaline | + |
| 24 | Arbutine | + |
| 25 | Esculine | + |
| 26 | Salicine | + |
| 27 | Cellobiose | + |
| 28 | Maltose | + |
| 29 | Lactose | + |
| 30 | Melibiose | + |
| 31 | Saccharose | + |
| 32 | Trehalose | + |
| 33 | Inuline | − |
| 34 | Melezitose | − |
| 35 | D-Raffinose | − |
| 36 | Amidon | − |
| 37 | Glycogene | − |
| 38 | Xylitol | − |
| 39 | β Gentiobiose | + |
| 40 | D-Turanose | − |
| 41 | D-Lyxose | − |
| 42 | D-Tagatose | + |
| 43 | D-Fucose | − |
| 44 | L-Fucose | − |
| 45 | D-Arabitol | − |
| 46 | L-Arabitol | − |
| 47 | Gluconate | + |
| 48 | 2 Keto-gluconate | − |
| 49 | 5 Keto-gluconate | − |

According to the process of an embodiment of the present invention, micronized full-fat soy flour is used while lactic acid fermentation and the action of transglutaminase enzyme contribute to the coagulation and bonding of soy proteins so that smooth-textured, functional, bean curd comprising probiotic lactobacillus can be produced without a coagulant that is usually used for preparing bean curd.

In addition, the process according to embodiments of the present invention reduce loss in nutrition due to the occurrence of bean-curd dregs, loss in production yield and need for removing waste water, etc. Therefore, production cost can be saved thanks to improvements in production yield and efficiency for the utilization of raw materials, and an economic benefit can be obtained from reduced production time. In addition, according to an embodiment of the present invention, bean curd can be produced more hygienically without yielding any environmentally unfavorable wastes.

What is claimed is:

1. Tofu comprising:
microorganisms of Lactobacillus plantarum contained in Deposit No. KCCM10852P; and
a transglutaminase enzyme.

2. Tofu of claim 1, wherein the tofu contains the microorganisms in the number ranging from about 1×10⁸/g to about 9×10⁸/g.

3. Tofu of claim 1, wherein the tofu contains water in an amount from about 85 to about 90 wt %.

4. Tofu of claim 2, wherein the tofu has a hardness value from about 322 to about 368 dyn/cm², wherein the hardness value is obtainable by subjecting a cube of tofu (1.7×1.7×1.7 cm) to a test using Texture analyzer TA. XT. Plus available from Stable Micro Systems in U.K. under the conditions as set forth in the table:

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

5. Tofu of claim 2, wherein the tofu has a springiness value from about 0.84 to about 0.90%, wherein the hardness value is obtainable by subjecting a cube of tofu (1.7×1.7×1.7 cm) to a test using Texture analyzer TA. XT. Plus available from Stable Micro Systems in U.K. under the conditions as set forth in the table:

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

6. A method of making tofu, the method comprising:
providing soy milk;
adding to the soy milk a transglutaminase enzyme and microorganisms of Lactobacillus plantarum contained in Deposit No. KCCM10852P; and
aging the resulting composition for a period sufficient for fermentation by the microorganism, wherein the fermentation generates a coagulant for coagulating tofu.

7. The method of claim 6, wherein the period is from about 5 to about 12 hours.

8. The method of claim 6, wherein aging for fermentation is at a temperature from about 37 to about 45° C.

9. The method of claim 6, wherein the method does not comprise adding a coagulant other than that generated from the fermentation.

10. The method of claim 6, wherein the method does not comprise press-shaping the tofu.

11. The method of claim 6, wherein the resulting tofu contains the microorganisms in the number ranging from about 1×10⁸/g to about 9×10⁸/g.

12. The method of claim 6, wherein the tofu contains water in an amount from about 85 to about 90 wt %.

13. The method of claim 12, wherein the resulting tofu has a hardness value from about 322 to about 368 dyn/cm², wherein the hardness value is obtainable by subjecting a cube of tofu (1.7×1.7×1.7 cm) to a test using Texture analyzer TA. XT. Plus available from Stable Micro Systems in U.K. under the conditions as set forth in the table:

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

14. The method of claim 12, wherein the resulting tofu has a springiness value from about 0.84 to about 0.90%, wherein the hardness value is obtainable by subjecting a cube of tofu (1.7×1.7×1.7 cm) to a test using Texture analyzer TA. XT. Plus available from Stable Micro Systems in U.K. under the conditions as set forth in the table:

| | | |
|---|---|---|
| Pre-test speed | 5 | mm/sec |
| Test speed | 3 | mm/sec |
| Post-test speed | 5 | mm/sec |
| Distance | 10 | mm |
| Time | 3 | sec |
| Trigger force | 5 | g |

15. The method of claim 6, wherein providing the soy milk comprises adding water to micronized full-fat soy flour.
